(19) United States
(12) Patent Application Publication
(10) Pub. No.: US 2017/0052090 A1
(43) Pub. Date: Feb. 23, 2017

(54) CLIMATE VEHICLE WITH WIND TUNNEL AND METHOD FOR DYNAMICALLY TESTING VEHICLE COMPONENTS

(71) Applicant: IAV GmbH Ingenieurgesellschaft Auto und Verkehr, Berlin (DE)

(72) Inventors: Andreas Jentsch, Gifhorn (DE); Janek Junghans, Lehrte (DE); Kai-Alexander Marx, Hannover (DE); Arne Thormann, Gifhorn (DE)

(21) Appl. No.: 15/239,860

(22) Filed: Aug. 18, 2016

(30) Foreign Application Priority Data
Aug. 18, 2015 (DE) 10 2015 113 610.4

(51) Int. Cl. G01M 9/04; G01N 17/00

(52) U.S. Cl. CPC G01M 9/04; G01N 17/002

(57) ABSTRACT

A climate vehicle for testing a vehicle component under defined climate conditions includes a cabin that is separated by a cabin shell from a climate vehicle environment surrounding the climate vehicle. A climate control unit is arranged in the cabin and configured to control the climate of the air that is present in the cabin. A fan is configured to accelerate the climate-controlled air in a defined direction. A tunnel with an inlet opening is configured to receive the accelerated climate-controlled air. The tunnel has a tubular tunnel part configured to convey the accelerated climate-controlled air. The tubular tunnel part has a section that accommodates the vehicle component to be tested. The tunnel has an outlet opening configured to release the conveyed accelerated climate-controlled air into the cabin.

### CROSS-REFERENCE TO PRIOR APPLICATION

Priority is claimed to German Patent Application No. DE 10 2015 113 610.4, filed on Aug. 18, 2015, the entire disclosure of which is hereby incorporated by reference herein.

### FIELD

The invention relates to a climate vehicle with a wind tunnel for dynamically testing vehicle components under defined kinetic and climate conditions, and it also relates to a method for dynamically testing vehicle components under defined kinetic and climate conditions.

### BACKGROUND

It is a known procedure to test vehicles and vehicle components under defined climate conditions. Stationary test installations, for example, test benches, are used in the development of vehicles and their components. Only once the vehicle is virtually ready for serial production are very expensive test drives carried out in climatically challenging regions. However, since even in these regions, the conditions are not the same all year round, the vehicle can usually only be tested at certain times of year. This problem has existed since vehicle components started being tested under defined climate conditions. This problem has been further exacerbated in recent times because the development cycles and vehicle life cycles have become increasingly shorter, meaning that testing has to be carried out all year round and can no longer be restricted only to certain seasons.

German Preliminary Published Application DE 28 46 742 A1 describes a temperature control installation for test objects, whereby the installation consists of a tunnel that can accommodate the test object, a fan and a cooling and/or heating system for the air that is blown by a fan. The test object is especially an internal combustion engine for motor vehicles. Moreover, the tunnel has openings for the lines, tubes, shafts and the like that are needed for the testing operations. Another aspect relates to the flow cross section established or formed in the tunnel between the test object and the tunnel walls surrounding it. This corresponds approximately to the flow cross section that is also encountered during the actual use of the object. This installation, which can be construed as the underlying state of the art, has two major drawbacks that can be ascribed to its principle of operation. On the one hand, a test can only be carried out during stationary operation. Dynamic influencing variables cannot be taken into consideration. On the other hand, the temperature range that can be generated, particularly in the direction of low temperatures, is limited due to its being a closed tunnel system, due to the resultant limited volume of air that can be blown, and due to the heat input stemming from the vehicle internal combustion engine, which is relatively high in comparison to the available volume.

German Preliminary Published Application DE 10 2009 020 601 A1 discloses an open-jet roller test bench for a motor vehicle, comprising a roller aggregate that supports the vehicle on its drive wheels and that is driven by the vehicle, a relative wind fan that strikes the front of the vehicle with an open air jet in a manner corresponding to the simulated driving speed, and also having a measuring system that determines the flow-dependent characteristic values. A realistic flow around the vehicle is achieved in that the relative wind fan is provided with a flow shield that extends from the fan outlet all the way to the front area of the vehicle, surrounding it close to the vehicle contours. There are no provisions for any climate control of the air that simulates the relative wind, which is why the test bench is designed as an open-jet test bench. Moreover, here, too, the operation is stationary. Consequently, no dynamic influencing variables can be tested.

Among the many other proposed test benches, mention should still be made of German patent specification DE 10 2005 006 081 B4. This document describes a test installation that tests clothing, protective gear and accessories for two-wheeled vehicles and that has a fan and a fan outlet that opens up into a test chamber. The test chamber of the portable test installation has an operating panel for a control unit to control the fan, whereby the operating panel is arranged on a two-wheeler located in the test chamber. The test installation is portable, preferably in that it is accommodated in a mobile container, but it can only be used in stationary operation. Consequently, no dynamic influencing variables can be tested.

German utility model DE 85 32 913 U1 discloses a device for the simulation of weather conditions in order to examine test objects, especially for testing motor vehicles or modules thereof The device is integrated into a large portable container and it comprises a climate chamber that accommodates the test object, associated sunshine simulation devices as well as means to maintain a predefinable climate temperature as well as a control room.

German Preliminary Published Application DE 101 55 245 A1 describes a means for simulating weather conditions, whereby a double-walled weather chamber is formed in which an interstice remains between the outer wall and the inner wall. The inner wall consisting of side walls, a floor and a ceiling forms the weather chamber. An air inlet opening of the weather chamber is situated in the ceiling, and there is an air outlet opening in the floor. This results in a flow direction from the top to the bottom in the weather chamber, thus achieving a largely uniform temperature distribution around the test object.

German patent application DE 44 22 039 A1 discloses a monitoring device for testing the functionality of electric components that do not have to be tested in extended-time testing installations under various conditions such as extreme temperatures, pressure fluctuations and high humidity, but rather under realistic environmental conditions. For this purpose, the monitoring device has sensors for acquiring environmental measured values, measuring instruments for acquiring function-related measured values for functional parameters, a comparison device for comparing the measured values to reference values, storage units that record deviating measured values together with the time-correlated environmental measured values or function-related measured values, and an output interface. In this manner, in case of a malfunction, it is possible to investigate the conditions that have led to the malfunction or to the failure of the component, even after the fact.

Other testing installations that are portable, but that can only be used in a stationary setting, are described in the following documents: German patent application DE 10 2009 020 182 A1, German utility model DE 20 2012 102 843 U1 as well as Japanese patent application JP H 08313390 A.

### SUMMARY

In an embodiment, the present invention provides a climate vehicle for testing a vehicle component under defined climate conditions. The climate vehicle includes a cabin that is separated by a cabin shell from a climate vehicle environment surrounding the climate vehicle. A climate control unit is arranged in the cabin and configured to control the climate of the air that is present in the cabin. A fan is configured to accelerate the climate-controlled air in a defined direction. A tunnel with an inlet opening is configured to receive the accelerated climate-controlled air. The tunnel has a tubular tunnel part configured to convey the accelerated climate-controlled air. The tubular tunnel part has a section that accommodates the vehicle component to be tested. The tunnel has an outlet opening configured to release the conveyed accelerated climate-controlled air into the cabin.

### BRIEF DESCRIPTION OF THE DRAWING

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 shows a schematic sectional view of a climate vehicle with a wind tunnel according to an embodiment of the present invention.

### DETAILED DESCRIPTION

In an embodiment, the present invention provides a device and a method that allows the testing of vehicle components under realistic conditions, especially under dynamic and climate-related conditions as well as subject to flow-technical influencing variables.

In an embodiment, the present invention provides a climate vehicle with a wind tunnel for testing a vehicle component under defined climate conditions, and, in another embodiment, provides a method for testing a vehicle component under defined climate conditions in a climate vehicle.

In an embodiment, the present invention provides a climate vehicle for testing a vehicle component under defined climate conditions. In order to carry out tests that are as realistic as possible, it is provided according to an embodiment to test the vehicle component to be tested in a moving object that transmits to the vehicle component the dynamic forces that will actually occur during later operation. The inventors have recognized a need for defined flow conditions in order for the vehicle component to be tested realistically. The object is itself a vehicle. Since the vehicle component to be tested is, in fact, tested not only under dynamic forces, but also under defined climate and flow-technical conditions, the object is referred to as a climate vehicle for purposes of making a clearer distinction. In this context, the climate vehicle is preferably a vehicle of the same model as the one from which the vehicle component to be tested stems. Aside from the preferred type of land vehicle, especially in the form of a motor vehicle, these could also conceivably be watercraft, aircraft or spacecraft. Since each type is subject to different dynamic influencing variables during operation, the most realistic approach is to use the same model in order to test the vehicle component to be tested. The vehicle component to be tested can be an individual component, a module consisting of individual components, or else a functional module such as a drive aggregate. Of course, an entire vehicle can also be tested, although this should take the cost-benefit aspect into consideration. The term “defined climate conditions” refers to a defined, that is to say, selectable temperature, humidity or air composition such as, for example, the fraction of substances that are dissolved or present in the form of an aerosol, such as salt mist or the like. Of course, the climate conditions can also be a combination of these three components. Preference is given to the setting of the defined temperature since this can cover most test scenarios. Defined flow-technical conditions relate to systematically blowing climate-controlled air having the defined composition onto the vehicle component to be tested, and this is done with a specified flow direction, flow angle and flow velocity.

The climate vehicle according to an embodiment of the invention has a cabin that is separated by a cabin shell from the climate vehicle environment surrounding the climate vehicle. The cabin has to be sealed so that defined climate conditions can be generated independently of the climate vehicle environment and, above all, so that these conditions can be kept constant. The cabin size has to allow a climate control that is financially feasible relative to the size of the vehicle component to be tested. If the cabin is too large, the climate control requirements are too costly. If it is too small, influencing factors of the vehicle component itself or other devices of the climate vehicle inside the cabin can cause the climate conditions to fluctuate excessively. The size of the cabin is defined by the cabin shell, which can, of course, also be partially formed by sections of a climate vehicle chassis or of a driver compartment wall. Preferably, the cabin is configured as a separate volume that is formed on all sides by a separate cabin shell. Conventionally, the cabin shell can be made of sheet metal and, as an alternative or in addition, can also comprise insulation materials, lightweight components and transparent or non-transparent glass components. The selection of the material of the cabin shell depends mainly on the type of climate vehicle and its environment as well as on the level of energy efficiency desired, or on the climate control performance that is available.

The climate vehicle according to an embodiment of the invention also has a climate control unit arranged in the cabin for controlling the climate of the air that is present in the cabin. Climate control units are generally known. They establish the temperature of the air that is drawn in. They are often able to set the humidity level at the same time. If certain fractions of substances that are dissolved or present in the form of an aerosol are to be introduced into the air, this can be done in the climate control unit itself or in a separate unit that is located upstream or downstream in the air flow. Analogously, certain substances that are dissolved in the air can be filtered out separately, or else this procedure can be integrated into the climate control unit. If air is being used here, this preferably refers to the air composition of the earth's atmosphere at ground level. The air pressure can be variable and is included in the defined climate conditions. As an alternative, the air can also be a special composition of individual gases or of several gases. This depends on the test purpose in question, but this will rarely be the case because of the desire for the conditions to be as realistic as possible. A known combination of a cabin and a climate control unit is the cooling compartment of a refrigerated truck. The climate control unit can also be arranged outside of the cabin and it then requires openings to remove and return the air. If the vehicle component to be tested is a watercraft, then the person skilled in the art will be aware that air, as the flow medium, can be replaced by water, as the flow medium. The climate control then takes place analogously. The same applies to the testing of vehicle components for spacecraft. Aside from the dynamic components, in this case, the test is characterized by a flow velocity of zero and a relatively low air pressure.

As another feature, the climate vehicle according to an embodiment of the invention has a fan to accelerate the climate-controlled air in a defined direction, that is to say, to generate a defined flow. Consequently, the function of the fan refers to its being a flow installation that can also be used analogously with other flow media. It is known that a fan, for example, a propeller or a blower, has a drive and comprises a fan inlet and a fan outlet. A fan serves to accelerate air, also referred to as the generation of wind. The terms “fan inlet” and “fan outlet” also refer to the front (upstream in the air flow) and the rear (downstream in the air flow) of the fan. They can have an open configuration like a propeller, or they can have a housing, like a blower. The direction of the accelerated air is established by the blade shape of the rotors of the fan and it generally matches the axis of the rotor. The fan or its rotor axis preferably has a fixed orientation, but it can also be variable, that is to say, it can change over time.

The climate vehicle according to an embodiment of the invention also comprises a tunnel with an inlet opening to receive accelerated climate-controlled air, with a tubular tunnel part to convey the accelerated climate-controlled air, and with an outlet opening to release the conveyed accelerated climate-controlled air into the cabin, whereby the tunnel has a section that accommodates the vehicle component to be tested. The inlet opening is preferably arranged downstream from the fan so that the air that is accelerated by the fan can enter the tunnel through the inlet opening. Whether the tunnel is arranged coaxially to the rotor axis of the fan or to the flow direction of the accelerated air or whether the air is conveyed from the fan to the inlet opening via deflection means such as, for example, additional angled tunnel segments, depends on the space available in the cabin, on the vehicle component to be tested, especially on its dimensions, as well as on the concrete test set-up, and this is done at the discretion of the person skilled in the art. The design of the outlet opening is analogous to this. Here, too, it has to be designed and arranged in such a way that the air can exit from the tunnel without encountering resistance. Preferably, the outlet opening has a curved configuration so that the exiting air is not conveyed perpendicular to a wall of the cabin, but rather tangential to it or in the direction of the central space of the cabin.

The tubular tunnel part for conveying the accelerated climate-controlled air has an entrance to the tunnel in the section that accommodates the vehicle component to be tested. This entrance can consist of a door or a similar closable and air-tight closure means. This section can be associated with a frame inside the tunnel to secure the vehicle component to be tested. This section can be associated with an insert that forms or models the actual physical situation in which the vehicle component to be tested is located at the installation site of the vehicle that is associated with said vehicle component. Finally, the tubular tunnel and the section that accommodates the vehicle component to be tested have openings for the placement of function and supply lines for the vehicle component as well as, if applicable, for lines that provide power for the measuring sensors and for transmitting the measured results. As an alternative, the measured values such as the temperature or the electrical characteristic values (current, voltage, resistance) can be transmitted wirelessly.

The climate vehicle according to an embodiment of the invention has two major advantages in comparison to the state of the art. The main advantage is the possibility of the dynamic testing of vehicle components. For instance, processes can be tested under defined climate and dynamic or kinetic conditions. These can include fluid conveying processes such as the behavior of an injection system. These can also include fluid storage systems such as a fuel tank or a fluid tank for exhaust gas after-treatment. These can also include individual components such as the suspension for an exhaust gas system whose vibration-damping components are made of rubber and whose behavior is to be tested when exposed to cold conditions and lateral accelerations. Finally, the vehicle component to be tested can be a complex aggregate such as an entire internal combustion engine. The second advantage is the possibility to generate constant climate conditions that, thanks to the arrangement of the open tunnel in a larger climate-controlled volume, is not sensitive to the heat input stemming from the vehicle component or from additional testing equipment.

In an advantageous embodiment of the present invention, in the flow direction of the accelerated climate-controlled air upstream from the section that accommodates the vehicle component to be tested, the tunnel part has an air guide element such as a baffle that is configured to deflect the accelerated climate-controlled air in the flow direction in such a way that air flows around the vehicle component to be tested under the same conditions as those present at the installation site in the vehicle associated with the vehicle component. This makes the test even more realistic.

In an alternative embodiment of the present invention, in the flow direction of the accelerated climate-controlled air upstream from the section that accommodates the vehicle component to be tested, the tunnel part has an air guide element such as a baffle that is configured to deflect the accelerated climate-controlled air in the flow direction in such a way that the climate-controlled air can flow at a maximum flow velocity against the vehicle component to be tested, without influencing the climate-controlled air at the vehicle component to be tested and/or at the tubular tunnel part due to turbulence within the fluid-dynamic boundary layer. The friction between the individual air molecules as well as between the air molecules and the wall areas of the vehicle component to be tested or the tunnel walls gives rise to the fluid-dynamic boundary layer that is familiar to the person skilled in the art. It should be present in the form of a laminar flow so that the flow velocity is not slowed down due to turbulence (turbulent flow). The person skilled in the art will select the aerodynamic configuration on the basis of the desired flow velocity and thus on the basis of the desired test velocity.

In another advantageous embodiment, the fan, especially its drive, is connected to a control unit for controlling the fan output, and the control unit is also connected to a velocity meter and/or a velocity indicator. This advantageously permits the control or regulation of the fan output as a function of the speed actually being driven by the climate vehicle, as a result of which the simulation is even more realistic. The velocity meter can be a wheel speed sensor or a control unit that evaluates this sensor signal, for example, an ESP control unit, that can be picked up by a CAN bus of the climate vehicle. As an alternative or in addition, the control unit can easily be connected to the speedometer of the climate vehicle.

In another embodiment, there is a heater in the section that accommodates the vehicle component to be tested. This heater can simulate other vehicle components such as, for example, an exhaust gas system. For this purpose, the heater is shaped and arranged in the same way as the exhaust gas system at the installation site of the vehicle component to be tested, that is to say, straight or curved, and above or below the vehicle component to be tested. Since defined climate conditions are being utilized here, the relevant temperature influences also have to be taken into account so that the testing can be carried out as realistically as possible.

Finally, in an especially advantageous embodiment of the invention, the tunnel and/or the fan can be removed, preferably without leaving anything behind. In this manner, the climate vehicle can be used for other purposes between individual test drives.

The invention also relates, in another embodiment, to a method for testing a vehicle component under defined climate conditions in a climate vehicle in which a tunnel with an inlet opening, a tunnel part and an outlet opening as well as a fan are secured in a cabin of the climate vehicle that is separated by a cabin shell from the climate vehicle environment, and this is done reversibly, that is to say detachably, or else irreversibly, that is to say, permanently non-detachably and not without leaving anything behind. Moreover, the vehicle component to be tested is arranged in a section that accommodates the vehicle component to be tested and that is associated with the tunnel part. This is done by opening the entrance to this section, inserting and fastening the vehicle component to be tested, and closing the entrance. Then a climate control unit that is arranged in the cabin and that serves for the climate control of the air present in the cabin is set to a target climate. This involves activating the climate control unit, preferably from the climate vehicle or from the driver compartment of the climate vehicle, then setting the target temperature, the target humidity and/or the target composition of the air, and starting the climate control unit.

Then, the fan or its drive are set at a given fan output as a function of a speed measured and/or displayed in the climate vehicle, or else it is set as a function of a predefined speed or speed profile. Finally, the climate vehicle is moved along a random or prescribed path. In this context, the climate vehicle is preferably operated by a test driver or test engineer, but it can also drive autonomously.

The device according to an embodiment of the invention and the method according to an embodiment of the invention make it possible for the first time to test vehicle components under realistic conditions, that is to say, incorporating dynamic and kinematic influencing variables such as acceleration forces or inertial forces.

In an advantageous embodiment of the method according to the invention, a properly oriented and shaped heater arranged in the section that accommodates the vehicle component to be tested is actuated as a function of the speed measured and/or displayed in the climate vehicle, and/or as a function of the time that has lapsed since the beginning of the test. In this manner, the influence of another vehicle component, for example, an exhaust gas system, can be simulated realistically. The faster the climate vehicle drives or the faster the speed profile of the fan is set, the higher the heater can be set. At the beginning of the test, the heater can be in the non-active state. The heating up of the heater can be delayed during a slow drive and accelerated during a fast drive.

Of course, before, during and/or after the test, the measured data is acquired by measuring sensors. This data can include temperature values or electric characteristic values, for example, current, voltage and/or resistance, that allow conclusions to be drawn about the behavior of the vehicle component to be tested.

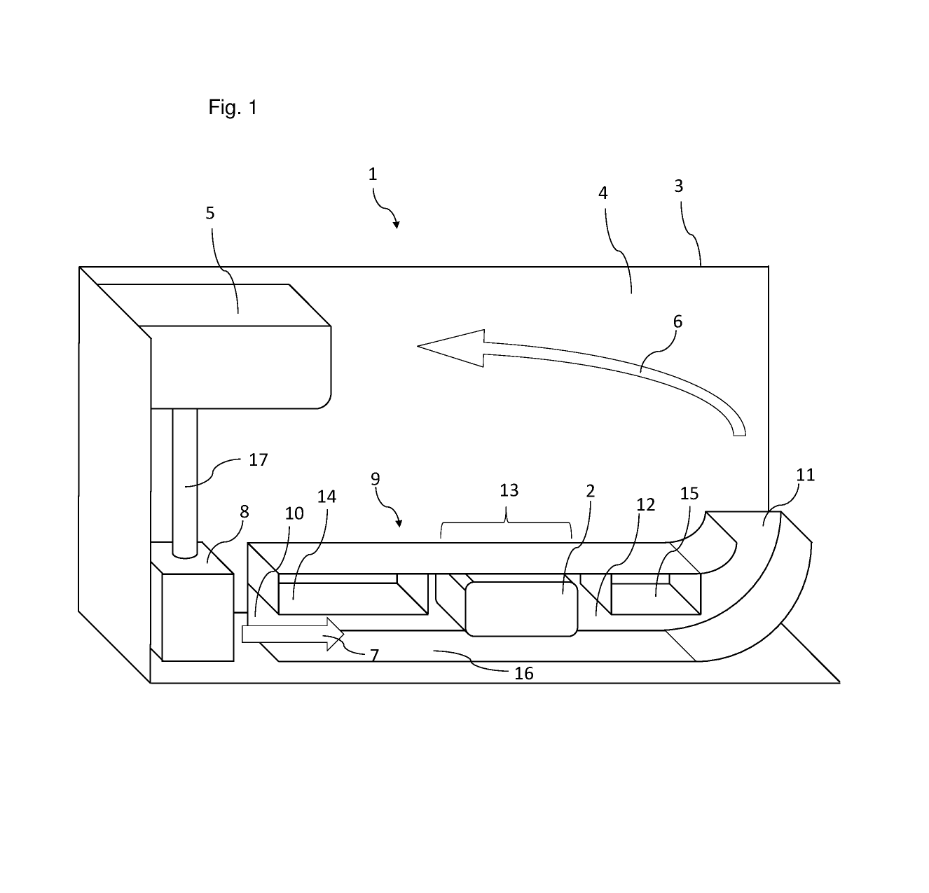

In this context, the sole FIG. 1 shows a schematic sectional view of a climate vehicle 1 with a wind tunnel 9. The climate vehicle 1 has a climate control unit 5. It can be permanently pre-installed or arranged reversibly. Conventional climate control units 5 that are used in refrigerated trucks can be regulated continuously as low as −30° C. This temperature range is sufficient for most climate tests. If even lower temperatures are needed, then improved climate control units 5 and better cabin insulation will be needed.

The cabin 4 of the climate vehicle 1 is indicated by the cabin shell 3. In the example shown, the cabin shell 3 corresponds to the right-hand outer wall of the cabin as seen in the driving direction of the climate vehicle 1. Such cabins 4 are known as closed insulated compartments of conventional refrigerated trucks and can be used as the simplest embodiment for the present invention. The air in the cabin 4 is indicated by the arrows with the reference numerals 6 and 7. The air is drawn in by the climate control unit 5, it is climate controlled, that is to say, cooled off, heated up, humidified or dehumidified, or else an aerosol, for instance, a salt mist, is added to it. Subsequently, the thus climate-controlled air is released in the direction of a fan 8. Advantageously, this is done via a connection tube 17, but this can also be carried out without a separate air duct. The fan 8 accelerates the climate-controlled air 7 in the direction of the inlet opening 10 of the wind tunnel 9. The extent to which the air is accelerated depends on a predefined speed profile or on the actually driven speed of the climate vehicle 1, which is received by a control unit of the fan 8 via a connection to the velocity meter or velocity indicator of the climate vehicle 1.

The wind tunnel 9 is configured as a tubular tunnel 12, here with a rectangular cross section. The tubular tunnel 12 has a section 13 that accommodates a vehicle component 2 to be tested. In the present example, this is a reducing agent tank 2. Reducing agent in the form of an aqueous urea solution freezes at −11° C. This is why these tanks are normally equipped with heaters. In order to test whether they are functioning and are adequately dimensioned, that is to say, whether they can generate sufficient heat output, there is a need for realistic tests that also include the movement of the reducing agent. This is why a sufficiently cold environment has to be created in order to take into account the speed-dependent relative wind.

The accelerated climate-controlled air 7 flows through the tubular tunnel part 12 and flows around the reducing agent tank 2 in the same way as the relative wind would once it is in its future installed site. In order to achieve this, air conveying elements 14 and 15 are arranged in the flow direction of the air 7 upstream and downstream from the reducing agent tank 2. In particular, the air conveying elements 14, 15 ensure a given distance between the bottom 16 of the wind tunnel and the air conveying elements 14, 15 that corresponds to the distance between the road surface and the vehicle chassis during later use. As an alternative, the distance between the bottom 16 of the wind tunnel and the air conveying elements 14, 15 can be selected in such a way that the highest possible vehicle speeds can be simulated by means of the highest possible flow velocity of the climate-controlled air 7, without influencing the flow along the reducing agent tank 2 due to turbulence on the walls of the wind tunnel 9 or on the floor (fluid-dynamic boundary layer). The air conveying elements 14 and 15 can be additionally profiled or can be equipped with air turbulence devices such as spoilers and/or diffusers. The extension in the crosswise direction of the vehicle is large enough to prevent air flows that do not conform to realistic scenarios. Preferably, the air conveying elements 14 and 15 extend over the entire width of the wind tunnel 9.

The air subsequently flows out of the wind tunnel 9 through the outlet opening 11 and further in the direction 6 of the climate control unit 5. The heat that is input into the air by the heater that is installed in the reducing agent tank 2 is distributed throughout the entire cabin 4 after the air has exited. As a result, the temperature differential of the air upstream and downstream from the climate control unit 5 is quite small, as a result of which the target temperature of the air can reliably be set at a constant value.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 climate vehicle

2 vehicle component (reducing agent tank)

3 outer wall of the cabin

4 cabin

5 climate control unit

6 air flow between the wall tunnel and the climate control unit

7 air flow between the fan and the wind tunnel

8 fan

9 wind tunnel

10 inlet opening of the wind tunnel

11 outlet opening of the wind tunnel

12 tubular tunnel part

13 section that accommodates the vehicle component to be tested

14 upstream air conveying element

15 downstream air conveying element

16 bottom of the tunnel

17 connection tube

1. A climate vehicle for testing a vehicle component under defined climate conditions, the climate vehicle comprising:
a cabin that is separated by a cabin shell from a climate vehicle environment surrounding the climate vehicle,
a climate control unit arranged in the cabin and configured to control the climate of the air that is present in the cabin,
a fan configured to accelerate the climate-controlled air in a defined direction, and
a tunnel with an inlet opening configured to receive the accelerated climate-controlled air, the tunnel having a tubular tunnel part configured to convey the accelerated climate-controlled air, the tubular tunnel part having a section that accommodates the vehicle component to be tested, and the tunnel having with-an outlet opening configured to release the conveyed accelerated climate-controlled air into the cabin.

2. The climate vehicle according to claim 1, wherein, in the a flow direction of the accelerated climate-controlled air upstream from the section that accommodates the vehicle component to be tested, the tunnel part has an air guide element that is configured to deflect the accelerated climate-controlled air in the flow direction in such a way that air flows around the vehicle component to be tested under the same flow conditions as those present at the an installation site in the a vehicle associated with the vehicle component.

3. The climate vehicle- according to claim 1, wherein, in a flow direction of the accelerated climate-controlled air upstream from the section that accommodates the vehicle component to be tested, the tunnel part has an air guide element that is configured to deflect the accelerated climate-controlled air in the flow direction in such a way that the climate-controlled air is flowable at a maximum flow velocity against the vehicle component to be tested, without influencing the climate-controlled air at the vehicle component to be tested and/or at the tubular tunnel part 12 due to turbulence within a fluid-dynamic boundary layer.

4. The climate vehicle according to claim 1, wherein the fan is connected to a control unit configured to control fan output as a function of a speed actually being driven by the climate vehicle, and wherein the control unit is also connected to a velocity meter and/or a velocity indicator.

5. The climate vehicle according to claim 1, further comprising a heater disposed in the section that accommodates the vehicle component to be tested.

6. The climate vehicle according to claim 1, wherein the tunnel and/or the fan are removable.

7. A method for testing a vehicle component under defined climate conditions in a climate vehicle, the method comprising:
securing, reversibly or irreversibly, a tunnel with an inlet opening, a tunnel part, an outlet opening and a fan in a cabin of the climate vehicle that is separated by a cabin shell from a climate vehicle environment,
arranging the vehicle component to be tested in a section that accommodates the vehicle component to be tested and that is associated with the tunnel part,
setting a climate control unit that is arranged in the cabin and that serves for the climate control of the air present in the cabin to a target climate,
setting the fan at a given fan output as a function of a speed measured and/or displayed in the climate vehicle, or setting the fan as a function of a predefined speed, and
moving the climate vehicle along a random or prescribed path.

8. The method according to claim 7, wherein a properly oriented and shaped heater arranged in the section that accommodates the vehicle component to be tested is actuated as a function of the speed measured and/or displayed in the climate vehicle, and/or as a function of the time that has lapsed since the beginning of the test.
